(19) United States
(12) Patent Application Publication
(10) Pub. No.: US 2014/0111173 A1
(43) Pub. Date: Apr. 24, 2014

(54) LOW DROP-OUT REGULATOR

(71) Applicant: SAMSUNG ELECTRO-MECHANICS CO., LTD., Suwon (KR)

(72) Inventor: Soo Woong LEE, Suwon (KR)

(73) Assignee: SAMSUNG ELECTRO-MECHANICS CO., LTD., Suwon (KR)

(21) Appl. No.: 13/740,751

(22) Filed: Jan. 14, 2013

(30) Foreign Application Priority Data
Oct. 18, 2012 (KR) 10-2012-0115883

(51) Int. Cl. G05F 1/613

(52) U.S. Cl. CPC G05F 1/613
USPC 323/281

(57) ABSTRACT

There is provided a low drop-out regulator. The low drop-out regulator includes a reference voltage generating unit converting input power to generate a reference voltage; an amplifier comparing the reference voltage and a feedback voltage to output a gate signal; a pass transistor array unit including a first transistor and a second transistor respectively including a gate receiving the gate signal; a voltage detector detecting the feedback voltage and an output voltage by using a switching operation of the pass transistor array unit; and a controller shutting off the gate signal applied to either of the first transistor or the second transistor, according to the reference voltage and the input power.

### CROSS-REFERENCE TO RELATED APPLICATIONS

This application claims the priority of Korean Patent Application No. 10-2012-0115883 filed on Oct. 18, 2012, in the Korean Intellectual Property Office, the disclosure of which is incorporated herein by reference.

### BACKGROUND OF THE INVENTION

1. Field of the Invention

The present invention relates to a low drop-out regulator.

2. Description of the Related Art

A voltage regulator is a circuit used in various electronic devices. For example, a direct current (DC) voltage regular may be embodied in connection with a static circuit for generating an output voltage that is rectified from a variable input DC voltage. In this case, the output voltage needs to be constantly maintained in spite of a change in output load current and input voltage. In particular, one type of voltage regulator widely used in industrial fields of application is a low drop-out regulator. Among the voltage regulators, a low drop-out regulator outputs an adjusted voltage that is obtained by performing a low voltage drop on a power voltage.

When a low drop-out regulator having variable input power is designed, a pass transistor that can operate at a highest voltage within a variable range of the input power is used. However, since such a pass transistor has a higher on-resistance and turn-on voltage than those of a pass transistor that is designed to operate at a relatively low voltage, when the pass transistor that is designed to operate at a highest voltage operates at a lowest voltage of the input power, a normal output voltage cannot be obtained from the low drop-out regulator.

In order to resolve this defect, a ratio of width versus length (W/L) of the pass transistor is increased. However, in this case, parasitic impedance increases.

The following related art document discloses a four-terminal SOI-MESFET-based low drop-out regulator that includes an operational amplifier, a pass transistor, a voltage dividing resistor, and so on and uses a SOI-MESFET as a pass transistor. However, the following related art document does not disclose a plurality of pass transistors, in particular, a method of selecting a pass transistor that can perform a reliable operation in a range of variable input power, from among the plurality of pass transistors.

### RELATED ART DOCUMENT

U.S. Patent Laid-Open Publication No. 2011/0285456

### SUMMARY OF THE INVENTION

An aspect of the present invention provides a low drop-out regulator for which a pass transistor capable of performing a reliable operation when a variable input power voltage is applied thereto can be selected from among a plurality of pass transistors.

According to an aspect of the present invention, there is provided a low drop-out regulator, including: a reference voltage generating unit converting input power to generate a reference voltage; an amplifier comparing the reference voltage and a feedback voltage to output a gate signal; a pass transistor array unit including a first transistor and a second transistor respectively including a gate receiving the gate signal; a voltage detector detecting the feedback voltage and an output voltage by using a switching operation of the pass transistor array unit; and a controller shutting off the gate signal applied to either of the first transistor or the second transistor, according to the reference voltage and the input power.

The first transistor and the second transistor may respectively include a p-type metal oxide semiconductor field effect transistor (P-MOSFET) including a source connected to the input power, and a drain connected to the voltage detector.

The pass transistor array unit may further include a first switch connecting a gate of the first transistor and an output terminal of the amplifier; and a second switch connecting a gate of the second transistor and an output terminal of the amplifier.

The controller may generate a first signal by comparing the reference voltage and the input power, and a second signal obtained by inverting the first signal.

The controller may include a comparer comparing the reference voltage and the input power to output the first signal; and an inverter inverting the first signal to output the second signal.

The comparer may include an inverting terminal to which the reference voltage is input; a non-inverting terminal to which the input power is input; and an output terminal outputting the first signal.

The controller may generate a first signal by comparing the reference voltage and the input power, and a second signal obtained by inverting the first signal, and the first signal and the second signal may be transmitted to different respective switches from among the first switch and the second switch.

The first switch and the second switch may perform switching operations according to different on/off timings.

The voltage detector may include a first resistor having one end connected to the pass transistor array unit; and a second resistor including one end connected to the other end of the first resistor, and the other end connected to a ground.

The voltage detector may detect the feedback voltage according to a resistance ratio of the first resistor and the second resistor and may detect the output voltage according to total resistance of the first resistor and the second resistor.

According to another aspect of the present invention, there is provided a low drop-out regulator, including: a reference voltage generating unit converting input power to generate a reference voltage; an amplifier comparing the reference voltage and a feedback voltage to output a gate signal; a pass transistor array unit including a first switch having one end connected to an output terminal of the amplifier, a second switch having one end connected to the output terminal of the amplifier, a first transistor having a gate connected to the other end of the first switch, a second transistor having a gate connected to the other end of the second switch, a third switch connecting the first switch, a connecting node of the first transistor and an input terminal of the input power to one another, and a fourth switch connecting the second switch, a connecting node of the second transistor and the input terminal of the input power to one another; a voltage detector detecting the feedback voltage and an output voltage by using a switching operation of the pass transistor array unit; and a controller controlling switching operations of the first switch, the second switch, the third switch, and the fourth switch according to the reference voltage and the input power.

The first transistor and the second transistor may respectively include a P-MOSFET including a source connected to the input power, and a drain connected to the voltage detector.

The controller may generate a first signal by comparing the reference voltage and the input power, and a second signal obtained by inverting the first signal.

The controller may include a comparer comparing the reference voltage and the input power to output the first signal; and an inverter inverting the first signal to output the second signal.

The comparer may include an inverting terminal to which the reference voltage is input; a non-inverting terminal to which the input power is input; and an output terminal outputting the first signal.

The controller may generate a first signal by comparing the reference voltage and the input power, and a second signal obtained by inverting the first signal, and the first signal and the second signal may be transmitted to different respective switching units from among a first switching unit including the first switch and the fourth switch and a second switching unit including the second switch and the third switch.

The first switch and the second switch may perform switching operations according to different on/off timings, and the third switch and the fourth switch may perform switching operations according to different on/off timings.

The voltage detector may include a first resistor having one end connected to the pass transistor array unit; and a second resistor including one end connected to the other end of the first resistor, and the other end connected to a ground.

The voltage detector may detect the feedback voltage according to a resistance ratio of the first resistor and the second resistor and may detect the output voltage according to total resistance of the first resistor and the second resistor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a low drop-out regulator according to an embodiment of the present invention;

FIG. 2 is a circuit diagram of a low drop-out regulator according to an embodiment of the present invention;

FIG. 3 is a circuit diagram of a controller that is a component of the low drop-out regulator of FIG. 2, according to an embodiment of the present invention;

FIG. 4 is a circuit diagram of a low drop-out regulator according to another embodiment of the present invention; and

FIG. 5 is a circuit diagram of a controller that is a component of the low drop-out regulator of FIG. 4, according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

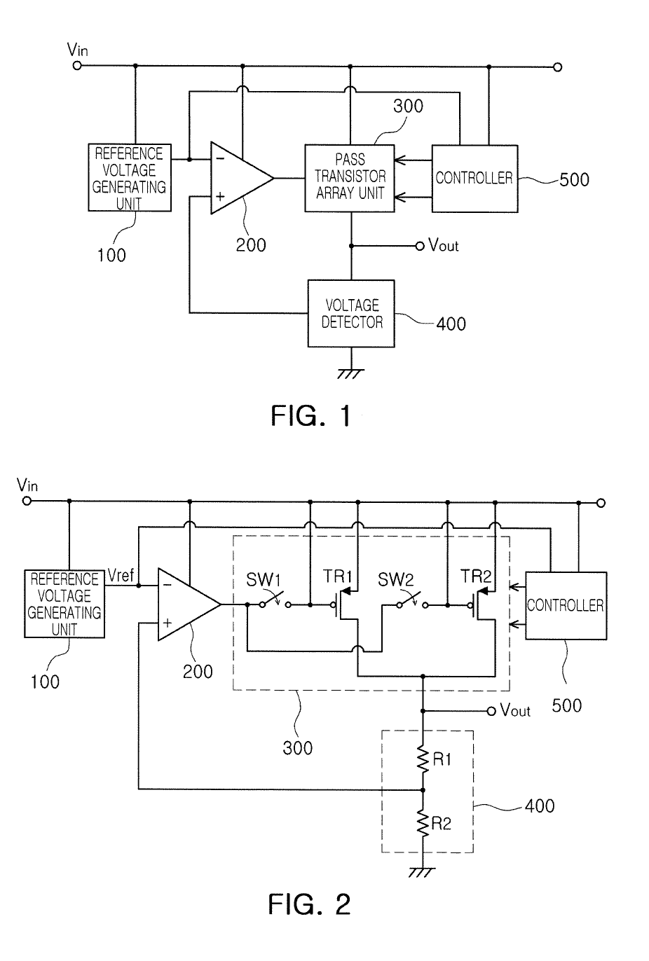

FIG. 1 is a block diagram of a low drop-out regulator according to an embodiment of the present invention. Referring to FIG. 1, the low drop-out regulator according to the present embodiment may include a reference voltage (Vref) generating unit 100, an amplifier 200, a pass transistor array unit 300, a voltage detector 400, and a controller 500.

The reference voltage (Vref) generating unit 100 may convert an input power voltage Vin to generate a reference voltage Vref. The generated reference voltage Vref may be provided to an inverting terminal of the amplifier 200 and the controller 500.

The amplifier 200 may amplify a voltage difference between the reference voltage Vref and a feedback voltage and may output a gate signal. In detail, the inverting terminal of the amplifier 200 may receive the reference voltage Vref and a non-inverting terminal may receive the feedback voltage. The output gate signal may be provided to the pass transistor array unit 300 and may control switching of respective pass transistors included in the pass transistor array unit 300.

The pass transistor array unit 300 may include a plurality of pass transistors receiving a gate signal and performing a switching operation. When a pass transistor is turned on, a flow of a current may be generated according to a magnitude of the input power voltage Vin applied to a source of the pass transistor and a voltage of the gate signal. When the pass transistor is turned off, the flow of the current may be shut off in the pass transistor.

The voltage detector 400 may detect current generated via the switching operation of the pass transistor array unit 300 as a voltage. In detail, the voltage detector 400 may include a first resistor R1 and a second resistor R2 that are connected to each other in series and may detect the feedback voltage applied to the amplifier 200 according to a resistance ratio of the first resistor R1 and the second resistor R2. In addition, the voltage detector 400 may detect an output voltage Vout of the low drop-out regulator according to total resistance of the first resistor R1 and the second resistor R2, that is, the sum of resistances of the first resistor R1 and the second resistor R2.

In detail, the voltage detector 400 may include the first resistor R1 having one end connected to the pass transistor array unit 300, and the second resistor R2 having one end connected to the other end of the first resistor R1 and the other end connected to a ground. In this case, an output terminal of the low drop-out regulator may be connected to a node between the pass transistor array unit 300 and the first resistor R1, and the non-inverting terminal of the amplifier 200 may be connected to a node between the first resistor R1 and the second resistor R2.

The controller 500 may compare the reference voltage Vref and the input power voltage Vin and may determine whether gate signals applied to the plurality of pass transistors included in the pass transistor array unit 300 are shut off. In addition, the controller 500 may select a transistor that is turned off, from among the plurality of pass transistors included in the pass transistor array unit 300.

FIG. 2 is a circuit diagram of a low drop-out regulator according to an embodiment of the present invention. Operations of the reference voltage (Vref) generating unit 100, the amplifier 200, and the voltage detector 400 shown in FIG. 2 are the same as those of the reference voltage (Vref) generating unit 100, the amplifier 200, and the voltage detector 400 shown in FIG. 1, and thus, are not described herein.

The pass transistor array unit 300 may include a first transistor TR1 and a second transistor TR2. Each of the first transistor TR1 and the second transistor TR2 may include agate receiving a gate signal output from an output terminal of the amplifier 200. The first transistor TR1 and the second transistor TR2 are each shown as a P-MOSFET, which are merely examples, and the present invention is not limited thereto. That is, the first transistor TR1 and the second transistor TR2 may respectively be an n-type metal oxide semiconductor field effect transistor (N-MOSFET).

In addition, the pass transistor array unit 300 may include a first switch SW1 connecting the output terminal of the amplifier 200 to the gate of the first transistor TR1 and a second switch SW2 connecting the output terminal of the amplifier 200 to the gate of the second transistor TR2. On and off switching operations of the first switch SW1 and the second switch SW2 may be controlled by the controller 500.

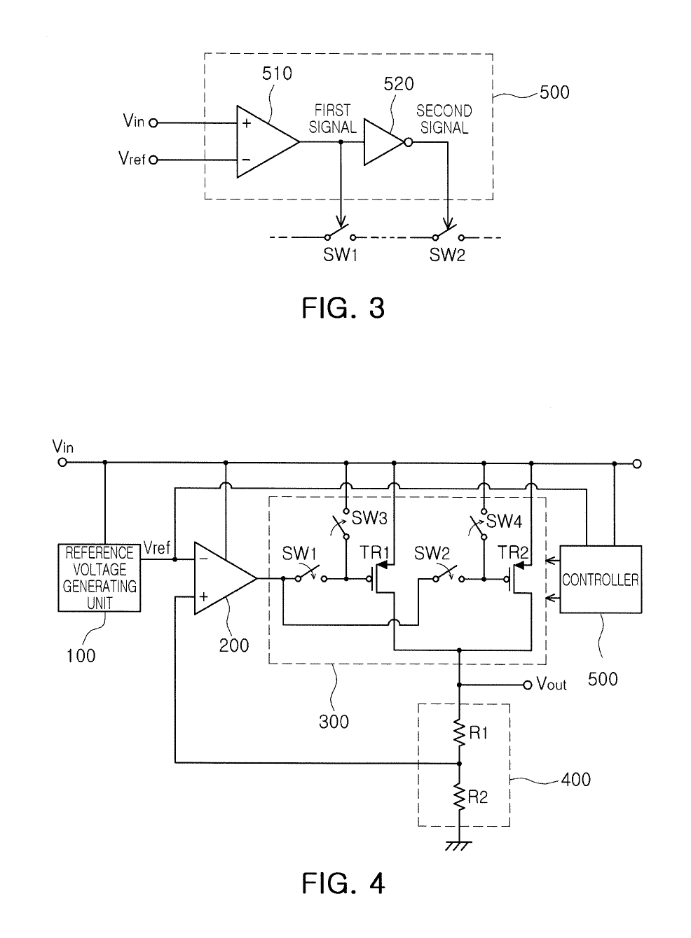

FIG. 3 is a circuit diagram of the controller 500 that is a component of the low drop-out regulator of FIG. 2, according to an embodiment of the present invention.

The controller 500 may compare the reference voltage Vref and the input power voltage Vin to output a first signal and may invert the first signal to output a second signal. In detail, the controller 500 may include a comparer 510 comparing the reference voltage Vref and the input power voltage Vin to output the first signal, and an inverter 520 inverting the first signal to output the second signal.

In this case, the first signal from the comparer 510 and the second signal output from the inverter 520 may be transmitted to different respective switches from among the first switch SW1 and the second switch SW2. In detail, when the first signal is transmitted to the first switch SW1, the second signal may be transmitted to the second switch SW2. When the first signal is transmitted to the second switch SW2, the second signal may be transmitted to the first switch SW1. When the first signal is a high or low level signal, since the second signal may be a low or high level signal, the first switch SW1 and the second switch SW2 which are respectively controlled by the first signal and the second signal may perform switching operations according to different on/off timings.

As an example of the controller 500 that is a component of the low drop-out regulator according to the present embodiment, the comparer 510 may include an inverting terminal to which the reference voltage Vref is input, a non-inverting terminal to which the input power voltage Vin is input, and an output terminal outputting the first signal.

In this case, when the input power voltage Vin is higher than the reference voltage Vref, the comparer 510 may output a high level signal and the inverter 520 may output a low level signal. The first signal that is a high level signal output from the comparer 510 may be transmitted to the first switch SW1, and the second signal that is a low level signal output from the inverter 520 may be transmitted to the second switch SW2. In addition, the first signal may control the first switch SW1 to perform an on-operation and the second signal may control the second switch SW2 to perform an off-operation.

Thus, since the gate signal output from the amplifier 200 may be applied to the gate of the first transistor TR1 and may not be applied to the gate of the second transistor TR2, the first transistor TR1 may operate as a pass transistor.

In this case, the first transistor TR1 operating as a pass transistor may have transistor characteristics so as to operate as a pass transistor when the input power voltage Vin is higher than the reference voltage Vref.

On the other hand, when the input power voltage Vin is lower than the reference voltage Vref, since the first signal is a low level signal and the second signal is a high level signal, the first switch SW1 may perform an off-operation and the second switch SW2 may perform an on-operation. In this case, the second transistor TR2 operating as a pass transistor may have transistor characteristics so as to operate as a pass transistor when the input power voltage Vin is lower than the reference voltage Vref.

That is, a pass transistor having appropriate transistor characteristics may be selected by comparing the input power voltage Vin with the reference voltage Vref when the input power voltage Vin varies.

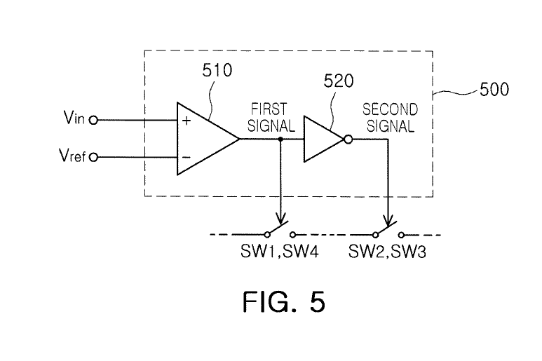

FIG. 4 is a circuit diagram of a low drop-out regulator according to another embodiment of the present invention. Operations of the reference voltage (Vref) generating unit 100, the amplifier 200, and the voltage detector 400 shown in FIG. 5 are the same operations as those of the reference voltage (Vref) generating unit 100, the amplifier 200, and the voltage detector 400 shown in FIG. 1, and thus, are not described herein.

The pass transistor array unit 300 may include the first switch SW1 having one end of an output terminal of the amplifier 200, the second switch SW2 having one end connected to the output terminal of the amplifier 200, the first transistor TR1 having a gate connected to the other end of the first switch SW1, the second transistor TR2 having a gate connected to the other end of the second switch SW2, a third switch SW3 connecting the first switch SW1, a connecting node of the first transistor TR1 and an input terminal of input power to one another, and a fourth switch SW4 connecting the second switch SW2, a connecting node of the second transistor TR2 and the input terminal of the input power to one another. The first transistor TR1 and the second transistor TR2 are shown as a P-MOSFET, which are merely an example, and the present invention is not limited thereto. That is, the first transistor TR1 and the second transistor TR2 may be an N-MOSFET.

FIG. 5 is a circuit diagram of the controller 500, a component of the low drop-out regulator of FIG. 4, according to another embodiment of the present invention. A detailed description of the controller 500 will be omitted and thus, differences thereof from the controller 500 of FIG. 3 will be mainly described.

A first signal from the comparer 510 of the controller 500 and the second signal output from the inverter 520 may be transmitted to different respective switching units from among a first switching unit including the first switch SW1 and the fourth switch SW4, and a second switching unit including the second switch SW2 and the third switch SW3.

As an example of the controller 500 that is a component of a low drop-out regulator according to the present embodiment, the comparer 510 may include an inverting terminal to which the reference voltage Vref is input, a non-inverting terminal to which input power is input, and an output terminal outputting the first signal.

In this case, when the input power voltage Vin is higher than the reference voltage Vref, the comparer 510 may output a high level signal and the inverter 520 may output a low level signal. The first signal that is a high level signal output from the comparer 510 may be transmitted to the first switch SW1 and the fourth switch SW4, and the second signal that is a low level signal output from the inverter 520 may be transmitted to the second switch SW2 and the third switch SW3. In addition, the first signal may control the first switch SW1 and the fourth switch SW4 to perform an on-operation and the second signal may control the second switch SW2 and the third switch SW3 to perform an off-operation.

In this case, since the second switch SW2 performs an off-operation, a gate signal output from the amplifier 200 may not be applied to the second transistor TR2. According to an embodiment of the present invention, when the first transistor TR1 and the second transistor TR2 are a P-MOSFET, since the fourth switch SW4 performs an on-operation, the input power voltage Vin that is a high level signal may be applied to the gate of the second transistor TR2 such that the second transistor TR2 is turned off, and thus, the second transistor TR2 does not operate. Thus, the first transistor TR1 may operate as a pass transistor.

In this case, the first transistor TR1 operating as a pass transistor may have transistor characteristics so as to operate as a pass transistor when the input power voltage Vin is higher than the reference voltage Vref.

On the other hand, when the input power voltage Vin is lower than the reference voltage Vref, the second transistor TR2 may operate as a pass transistor. In this case, the second transistor TR2 operating as a pass transistor may have transistor characteristics so as to operate as a pass transistor when the input power voltage Vin is lower than the reference voltage Vref.

That is, a pass transistor having appropriate transistor characteristics may be selected by comparing the input power voltage Vin with the reference voltage Vref when the input power voltage Vin varies.

As set forth above, according to the embodiments of the present invention, a pass transistor that may perform a reliable operation at a variable input power voltage may be selected from among a plurality of pass transistors, and thus, a normal output of a regulator may be obtained in a range of various input power.

In addition, parasitic impedance may be reduced compared with a case in which a ratio of width to length (W/L) of the pass transistor is increased.

While the present invention has been shown and described in connection with the embodiments, it will be apparent to those skilled in the art that modifications and variations can be made without departing from the spirit and scope of the invention as defined by the appended claims.

What is claimed is:

1. A low drop-out regulator, comprising:
a reference voltage generating unit converting input power to generate a reference voltage;
an amplifier comparing the reference voltage and a feedback voltage to output a gate signal;
a pass transistor array unit including a first transistor and a second transistor respectively including a gate receiving the gate signal;
a voltage detector detecting the feedback voltage and an output voltage by using a switching operation of the pass transistor array unit; and
a controller shutting off the gate signal applied to either of the first transistor or the second transistor, according to the reference voltage and the input power.

2. The low drop-out regulator of claim 1, wherein the first transistor and the second transistor respectively include a p-type metal oxide semiconductor field effect transistor (P-MOSFET) including a source connected to the input power, and a drain connected to the voltage detector.

3. The low drop-out regulator of claim 1, wherein the pass transistor array unit further includes a first switch connecting agate of the first transistor and an output terminal of the amplifier; and a second switch connecting a gate of the second transistor and an output terminal of the amplifier.

4. The low drop-out regulator of claim 1, wherein the controller generates a first signal by comparing the reference voltage and the input power, and a second signal obtained by inverting the first signal.

5. The low drop-out regulator of claim 4, wherein the controller includes a comparer comparing the reference voltage and the input power to output the first signal; and an inverter inverting the first signal to output the second signal.

6. The low drop-out regulator of claim 4, wherein the comparer includes an inverting terminal to which the reference voltage is input; a non-inverting terminal to which the input power is input; and an output terminal outputting the first signal.

7. The low drop-out regulator of claim 3, wherein the controller generates a first signal by comparing the reference voltage and the input power, and a second signal obtained by inverting the first signal, and the first signal and the second signal are transmitted to different respective switches from among the first switch and the second switch.

8. The low drop-out regulator of claim 7, wherein the first switch and the second switch perform switching operations according to different on/off timings.

9. The low drop-out regulator of claim 1, wherein the voltage detector includes a first resistor having one end connected to the pass transistor array unit; and a second resistor including one end connected to the other end of the first resistor, and the other end connected to a ground.

10. The low drop-out regulator of claim 9, wherein the voltage detector detects the feedback voltage according to a resistance ratio of the first resistor and the second resistor and detects the output voltage according to total resistance of the first resistor and the second resistor.

11. A low drop-out regulator, comprising:
a reference voltage generating unit converting input power to generate a reference voltage;
an amplifier comparing the reference voltage and a feedback voltage to output a gate signal;
a pass transistor array unit including a first switch having one end connected to an output terminal of the amplifier, a second switch having one end connected to the output terminal of the amplifier, a first transistor having a gate connected to the other end of the first switch, a second transistor having a gate connected to the other end of the second switch, a third switch connecting the first switch, a connecting node of the first transistor and an input terminal of the input power to one another, and a fourth switch connecting the second switch, a connecting node of the second transistor and the input terminal of the input power to one another;
a voltage detector detecting the feedback voltage and an output voltage by using a switching operation of the pass transistor array unit; and
a controller controlling switching operations of the first switch, the second switch, the third switch, and the fourth switch according to the reference voltage and the input power.

12. The low drop-out regulator of claim 11, wherein the first transistor and the second transistor respectively include a P-MOSFET including a source connected to the input power, and a drain connected to the voltage detector.

13. The low drop-out regulator of claim 11, wherein the controller generates a first signal by comparing the reference voltage and the input power, and a second signal obtained by inverting the first signal.

14. The low drop-out regulator of claim 10, wherein the controller includes a comparer comparing the reference voltage and the input power to output the first signal; and an inverter inverting the first signal to output the second signal.

15. The low drop-out regulator of claim 14, wherein the comparer includes an inverting terminal to which the reference voltage is input; a non-inverting terminal to which the input power is input; and an output terminal outputting the first signal.

16. The low drop-out regulator of claim 12, wherein the controller generates a first signal by comparing the reference voltage and the input power, and a second signal obtained by inverting the first signal, and the first signal and the second signal are transmitted to different respective switching units from among a first switching unit including the first switch and the fourth switch and a second switching unit including the second switch and the third switch.

17. The low drop-out regulator of claim 12, wherein the first switch and the second switch perform switching operations according to different on/off timings, and the third switch and the fourth switch perform switching operations according to different on/off timings.

18. The low drop-out regulator of claim 11, wherein the voltage detector includes a first resistor having one end connected to the pass transistor array unit; and a second resistor including one end connected to the other end of the first resistor, and the other end connected to a ground.

19. The low drop-out regulator of claim 17, wherein the voltage detector detects the feedback voltage according to a resistance ratio of the first resistor and the second resistor and detects the output voltage according to total resistance of the first resistor and the second resistor.
